(19) United States
(12) Patent Application Publication
(10) Pub. No.: US 2008/0168811 A1
(43) Pub. Date: Jul. 17, 2008

(54) MAGNETIC KEY FOR USE WITH A SECURITY DEVICE

(75) Inventor: Keith C. Nagelski, Huntersville, NC (US)

Correspondence Address: SAND & SEBOLT, AEGIS TOWER, SUITE 1100, 4940 MUNSON STREET, NW, CANTON, OH, 44718-3615, US

(73) Assignee: INVUE SECURITY PRODUCTS INC., Charlotte, NC (US)

(21) Appl. No.: 11/968,680

(22) Filed: Jan. 3, 2008

Related U.S. Application Data
(60) Provisional application No. 60/879,852, filed on Jan. 11, 2007.

(51) Int. Cl. E05B 47/00

(52) U.S. Cl. 70/276

(57) ABSTRACT

A key for unlocking a magnetically attractable locking mechanism retained within the interior of an anti-theft security device. The key comprises a housing which retains a dipole magnet therein. The dipole magnet is of a specifically designed cross-sectional shape configured to be complementary to a recess in the body of the security device. The shape of the magnet permits it to only enter the recess in one orientation and to bring only the appropriate one of the north or south magnetic poles into the proximity of the locking mechanism. The dipole magnet is movable in the housing between an extended position where at least a portion thereof protrudes from the housing, and a retracted position where the magnet is withdrawn entirely into the housing. The magnet is mounted on a spring-biased slide in the housing that is activated to move the magnet between the extended and retracted positions.

### CROSS-REFERENCE TO RELATED CASES

This is a standard utility application claiming priority from U.S. Provisional Application Ser. No. 60/879,852, filed Jan. 11, 2007, the entire disclosure of which is incorporated herein by reference.

### BACKGROUND OF THE INVENTION

1. Technical Field

This invention generally relates to security devices. More particularly, the invention relates to keys for unlocking security devices. Specifically, the invention relates to a magnetic key that includes a dipole magnet for unlocking a magnetically attractable locking mechanism on a security device.

2. Background Information

A variety of security devices are available on the market for deterring theft of items of merchandise. Some of these security devices are attached directly to individual items of merchandise and others are used to secure the systems that display the items of merchandise. A number of these security devices include locks which are unlocked using a magnet.

An example of a security device that is applied directly to an item of merchandise is that disclosed in UK patent application No. 2,305,212. This device includes a hook, which engages the item of merchandise, and a spring-biased lock that secures the hook in place. A magnet is positioned over the lock to unlock the system. The position of the lock is not immediately apparent but, nonetheless, the device is very easy to defeat. A would-be-thief could purchase an over-the-counter magnet at a hardware store or craft store, pass it over the entire housing and when the magnet comes into the proximity of the lock, it will simply unlock the device.

Similarly, French patent application number FR 2690421 discloses a security device for encasing an item of merchandise. Once again, the secure case includes a lock that is unlocked using a magnet. However, the position of this lock is very easy to detect in that the case includes a protrusion that houses the lock. Once again, any over-the-counter magnet can be brought into the vicinity of the lock to unlock the same.

This is also the case with the device shown in German patent DE19843036. This device is used to secure the display system and includes a lock for securing the display rods in place. However, as illustrated in FIG. 2 of the patent, any over-the-counter magnet may be merely positioned over the lock to unlock the same.

All of these above-referenced devices are vulnerable to unauthorized unlocking because of the relative accessibility of the locking system to potential thieves and because the only tool the potential thief needs, is a common bar magnet. Furthermore, using common bar magnets and the like to unlock locks may be problematic because of the nature of the magnets themselves. Magnets tend to be brittle and, consequently, if dropped, tend to chip. Chips can alter the magnetic field emanating from the magnet and therefore there tends to be a decrease in the magnet's magnetism after being dropped. Finally, magnets tend to attract metallic objects to themselves. So, if a store employee puts the magnet onto a key ring, for example, the magnet tends to attract surrounding objects such as keys and coins. This becomes a problem when the magnet needs to be used and all of the attracted objects have to be removed therefrom prior to its use.

These problems have been addressed to some degree in U.S. patent application Ser. No. 11/267,524, filed Nov. 4, 2005, published as Publication Serial No. 2006/0157431 by the inventors Nagelski et al, and assigned to the present assignee. In this application publication, a security device is disclosed that secures merchandise on a display rod. The device requires a specific magnetic key to unlock the same. The security device includes a lock with a magnetically attractable plunger housed in a chamber therein. The plunger moves linearly within the chamber between a locked position and an unlocked position. When the plunger is in the locked position it engages the display rod and prevents merchandise from being removed therefrom. When the plunger is in the unlocked position it does not engage the display rod and merchandise may therefore be removed from the rod. While the chamber is proximate the exterior surface of the device, it's existence and position would not be evident from a simple external examination of the device. Similarly, because of the key comprises a magnet that is completely surrounded by a housing, a simple external examination of the key would not reveal that there is a magnet in its interior. Even if it was determined that a magnet was needed to unlock the device, the location of the locking mechanism would be difficult to determine without spending a considerable amount of time manipulating the device and a bar magnet. This time spent would make it more likely that the thief will be caught in the act. The specially designed magnetic key for use by authorized personnel is disclosed in this publication as having a locating tab that must be engaged in a positioning groove in the exterior surface of the security device. This correctly positions the magnet on the exterior surface of the device and adjacent the locking mechanism. If the locating tab is not engaged in the positioning groove, then the magnet will not be correctly positioned on the security device's exterior surface, the plunger will not move and the device will remain locked.

There is therefore a need in the art for an improved magnetic key for unlocking improved security devices which include a magnetically attractable locking mechanism positioned within the interior of the device.

### SUMMARY OF THE INVENTION

The device of the present invention is a magnetic key for unlocking an improved security device. The security device in question forms the subject matter of two U.S. patent applications by the present inventor which are being concurrently filed herewith and are entitled “SECURITY DEVICE FOR LOCKING A PEG HOOK TO A PEG SUPPORT” and “HANG HOOK ASSEMBLY HAVING A SECURE FREE END”. The security devices disclosed in these applications include magnetically attractable locking systems that are contained within an interior chamber of the device and are not accessible or able to be activated, i.e., unlocked, by common over-the-counter magnets, such as bar magnets, placed on the outer surface of the security device.

The magnetic key of the present invention comprises a housing in which a dipole magnet is movably engaged. The dipole magnet is movable between a first retracted position where substantially the entire magnet is retained within the housing, and a second extended position where the magnet extends outwardly from the housing. The dipole magnet is formed into a pattern or shape that is complementary to a specifically designed or patterned recess formed in the security device. The shape of the dipole magnet and recess is such that the magnet can only enter the recess in one specific orientation. Furthermore, the dipole magnet is configured so as to bring only the necessary and appropriate north or south poles of the magnet into the proximity of the locking mechanism within the body of the security device. Finally, a dipole magnet is manufactured to be substantially stronger than a non-dipole, over-the-counter magnet of substantially the same size, and therefore has a stronger magnetic force field emanating from the body of the magnet. Consequently, the dipole magnet can unlock a locking mechanism positioned deeper within the interior of the security device than would be the case if the magnetic key included a non-dipole magnet.

The specially shaped dipole magnet is retained within the housing and is only extended outwardly from the housing when needed for unlocking of the security device. The dipole magnet is retracted or withdrawn into the housing when not in use. More specifically, the magnet is retained on a spring-biased slide that is activated to extend at least a portion of the dipole magnet out of the housing when needed. The housing provides protection to the dipole magnet so that if the key is dropped, the housing absorbs the impact of the blow, thus reducing the likelihood of chipping of the magnet and reduction of the magnetism of the same. Furthermore, the housing prevents objects surround the dipole magnet from contacting the same and acts as an insulator to lessen the magnetic attraction of the dipole magnet on surrounding objects.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is perspective view of the magnetic key in accordance with the present invention;

FIG. 2 is an exploded perspective view of the magnetic key of FIG. 1;

FIG. 3 is a perspective view of a radio frequency coil that may be included in the magnetic key;

FIG. 4 is a rear view of the dipole magnet of the magnetic key;

FIG. 5 is a side view of the dipole magnet;

FIG. 6 is a front view of the magnetic key with the dipole magnet extending outwardly away therefrom;

FIG. 7 is a cross-sectional top view of the magnetic key in the retracted inactive position taken through line 7-7 of FIG. 1;

FIG. 8 is a cross-sectional top view of the magnetic key in the extended active position; and

FIG. 9 is a side elevational view of the magnetic key engaged with a security device to unlock the same.

### DETAILED DESCRIPTION OF THE INVENTION

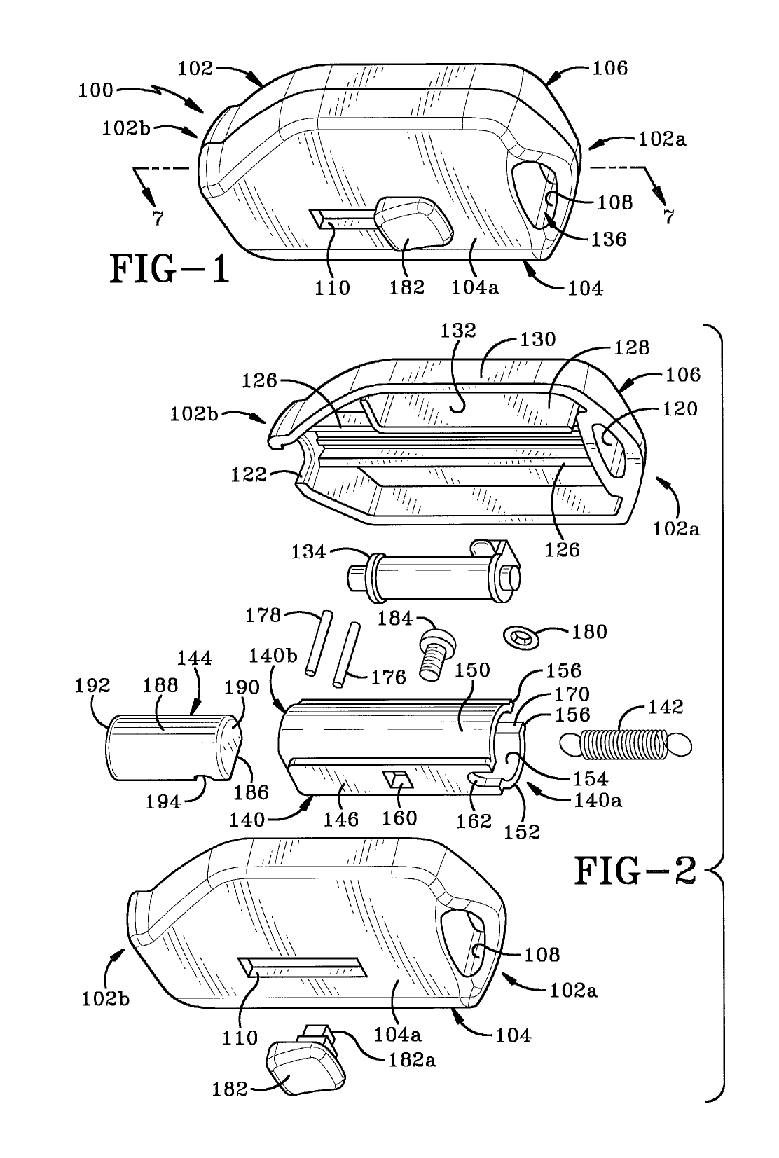

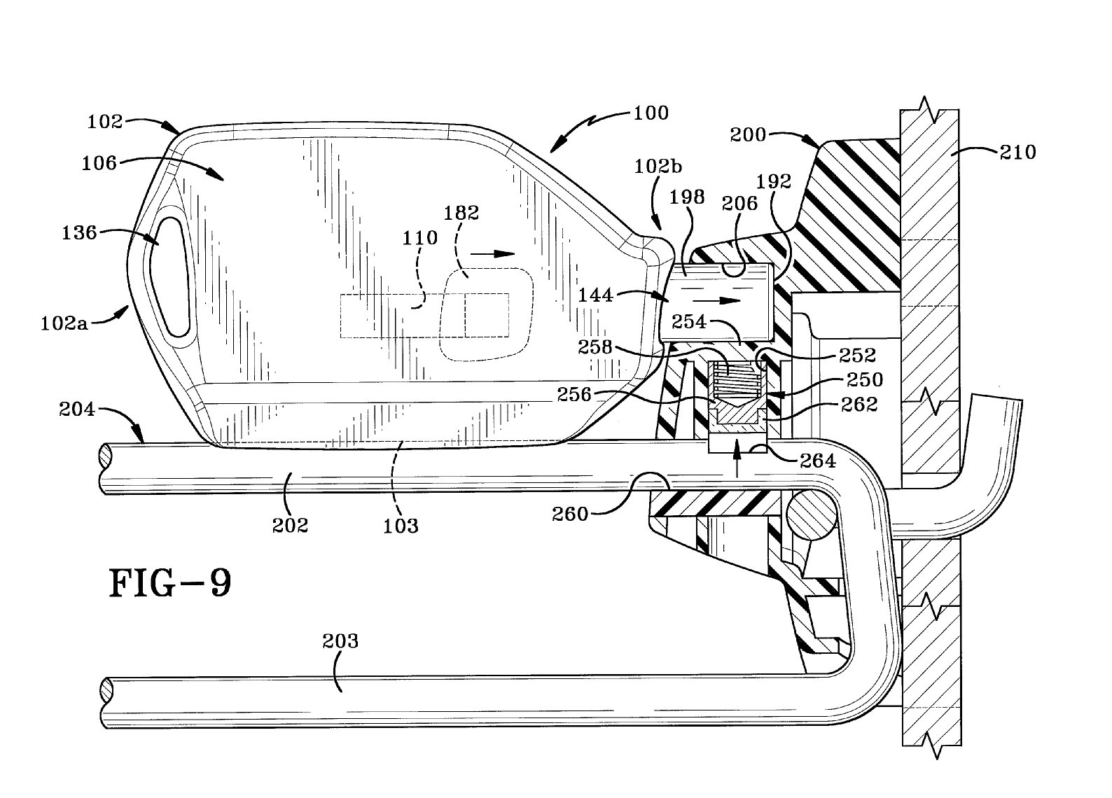

Referring to FIGS. 1-9, there is shown a magnetic key in accordance with the present invention and generally indicated at 100. Key 100 is adapted to unlock a security device 200 (FIG. 9) which forms part of a display system for items of merchandise (not shown) in order to deter and prevent theft of the items of merchandise.

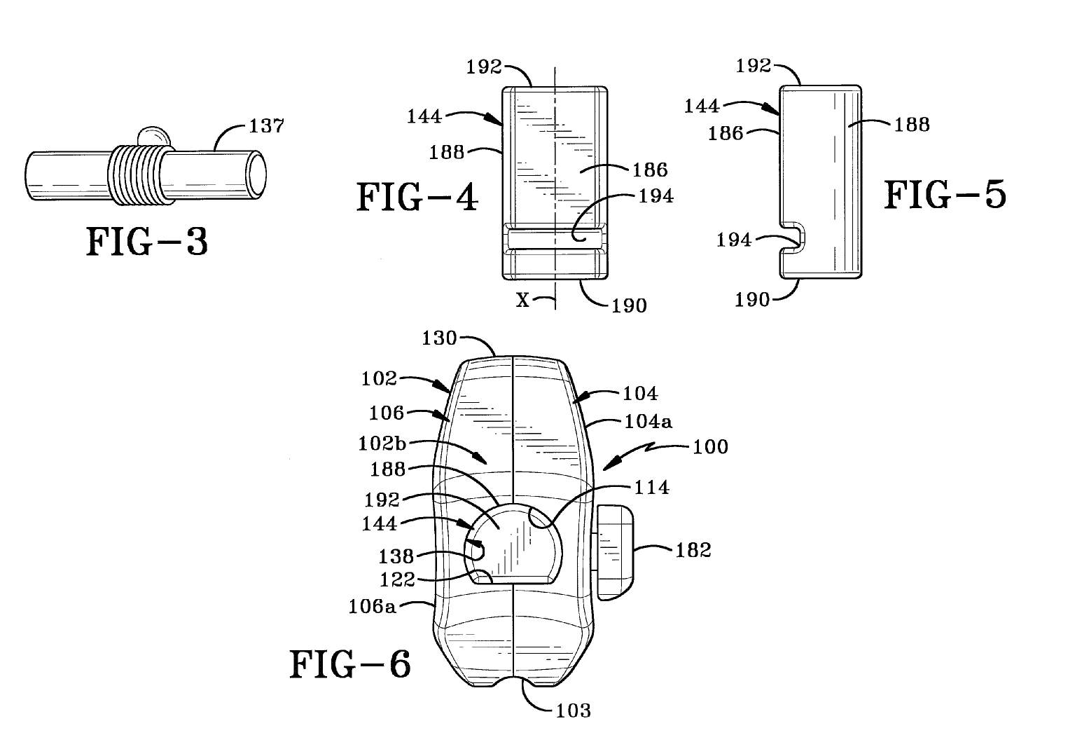

In accordance with the present invention, key 100 comprises a housing 102 made up of a first section 104 and a second section 106 that are joined together by ultrasonic welding, an adhesive, etc., to enclose a mechanism for unlocking security device 200. First section 104 of housing 102 comprises a wall having an outer surface 104a and an inner surface 104b. First section 104 defines a first aperture 108 proximate a first end 102a of housing and a longitudinal slot 110 that extends from outer surface 104a through to inner surface 104b. First section 104 also defines an interior chamber 112 within which the unlocking mechanism is partially housed. A first groove 114 (FIG. 3) is formed in second end 102b of housing 102. A post 116 extends outwardly away from the inner surface of first section 104 and into chamber 112. A pair of spaced apart ribs 118 (FIG. 4) are provided on the inner surface of first section 104 and extend from proximate first end 102a to proximate second 102b of housing.

Second section 106 of housing 102 comprises a wall that has an outer surface 106a and an inner surface 106b. Second section 106 defines a second aperture 120 proximate first end 102a and a second groove 122 proximate second end 102b. Second section 106 defines a second interior chamber 124. A plurality of longitudinal tracks 126 are provided on inner surface 106b of second section 106 and extend from proximate first end 102a to proximate end 102b of housing. Second section 106 is also provided with an interior wall 128 that extends outwardly away from the inner surface 106b and a spaced distance from tracks 126 and peripheral wall 130 of housing. A cavity 132 is defined between interior wall 128 and peripheral wall 130. Cavity 132 is sized to house one of a long AM coil 134 (FIG. 2) or a radio frequency (RF) coil 137 (FIG. 3). Coils 134 or 137 are incorporated into key 100 and will activate a door alarm system if the key 100 is removed from the store by an authorized person.

First and second sections 104, 106 are complementary in shape and when they are secured together, as by ultrasonic welding, first and second apertures 108, 120 are aligned and together form a hole 7 through which a lanyard (not shown) may be passed. The lanyard may then be secured to a store employee's key ring or belt so that key 100 is securely retained by the employee, but is still easily accessible for use. Furthermore, when first and second sections 104, 106 are secured together, first and second grooves 114, 122 form an opening 138 in second end 102b of housing 102.

In accordance with a specific feature of the present invention, opening 138 in housing 102 is specifically shaped to allow a substantially identically shaped portion of the unlocking mechanism of the key to travel in and out of the housing through opening 138. In the preferred embodiment of the invention, opening 138 is substantially D-shaped (FIG. 5). However, any other shapes can be utilized, such as a trapezoidal, hexagonal, or triangular shape, for example.

The key's unlocking mechanism is housed within the interior of housing 102 as formed by interior chambers 112, 124 of first and second sections 104, 106. The unlocking mechanism includes a slide 140 adapted for reciprocal movement along ribs 118 and 126; a spring 142 that biases slide 140 into a retracted position within housing 102; and a permanent dipole magnet 144 that is carried on slide 140 and is extendable outwardly through opening 138 when key 100 is activated by a store employee. Slide 140 includes a planar top and bottom wall 146, 148 with a pair of arcuate side walls 150, 152 extending between them. Slide 140 defines a longitudinal bore 154 that is accessible through both ends of slide 140. Side walls 150, 152 each terminate in a lip 156 (FIG. 2) and lips 156 are spaced a distance apart from each other. The distance is complementary to the distance between tracks 126. Lips 156 interlock the slide 140 on the tracks 126 and aid in guiding the slide 140 as it moves within housing 102. Slide 140 further includes an interior wall 158 (FIG. 3) that extends between top and bottom walls 146, 148 and perpendicular to the longitudinal axis of the bore 154. Top wall 146 of slide 140 defines an aperture 160 (FIG. 2) and an U-shaped slot 162 therein. The interior surface of top wall 146 also defines two spaced-apart recesses 164, 166 (FIG. 3). Bottom wall 148 of slide 140 defines an aperture 168 opposite aperture 160 in top wall 146 and defines a slot 170 positioned opposite slot 162 in top wall 146. Bottom wall 148 further defines two spaced-apart slots 174, 177 that are disposed opposite to and in alignment with recesses 164, 166. All of apertures 160, 168, slots 162, 170, 174, 177 and recesses 164, 166 are in communication with bore 154 of slide 140.

A first pin 176 is retained in the first aligned recess and slot 164, 174. A second pin 178 is retained in the second aligned recess and slot 166, 177. Spring 142 extends between post 116 and first pin 176 and is retained on post 116 by a push nut 180. Slots 162 and 170 are provided on slide 140 to allow a first end 146a of slide 140 to move a small distance beyond post 116 when slide 140 is moved along tracks 126.

Slide 140 is connected to an activation button 182 by a screw 184. An end portion 182a of button 182 (FIG. 2) is inserted through slot 110 in first section 104 of housing 102 and fits tightly into aperture 160 of slide 140. Screw 184 is inserted through aperture 168 in bottom wall 148 of slide 140, through slot 110 in first section 104 and into a bore within button 182. A tip of a screwdriver may be inserted through slot 168 to tighten screw 184.

Referring to FIGS. 4 & 5, and in accordance with a specific feature of the present invention, the unlocking mechanism further includes a permanent dipole magnet 144. Permanent dipole magnets are magnets which are specifically manufactured from a plurality of smaller magnetic blocks. The blocks are arranged and secured to each other in a particular manner so as to produce a magnet having a north pole in a first predetermined region and a south pole in a second predetermined position. When compared to traditional magnets of similar size, dipole magnets have a far greater magnetic strength. The dipole magnet 144 utilized in the present invention is manufactured from an alloy of neodymium, iron and boron (NdFeB). Specifically, the preferred magnet 144 is a sintered NdFeB magnet that is nickel plated.

In accordance with another specific feature of the present invention, dipole magnet 144 is shaped and elongated to fit within a portion 154a of bore 154 of slide 140. Magnet 144 has a longitudinal axis “X” that is substantially aligned with the longitudinal axis of slide 140 and of housing 102. Magnet 144 is also specially manufactured to have a specific cross-sectional profile so that it can be engaged in a specially designed and shaped recess in security device 200. In the preferred embodiment of the invention shown in FIGS. 1-6, the cross-sectional profile of magnet 144 is substantially D-shaped and is designed to be received within a complementary D-shaped recess within security device 200. Magnet 144 includes an elongated wall having planar face 186 and an arcuate face 188. Arcuate face 188 originates and terminates in planar face 186 to form the D-shape. Magnet 144 is an elongated member that further includes end faces 190, 192. Planar face 186 is provided with a channel 194 oriented at right angles to the longitudinal axis of the magnet and is sized to receive second pin 178 of slide 140 therein. It should be noted that slide 140 and magnet 144 are configured to be sufficiently complementary in shape that magnet 144 is tightly retained against at least a portion of the interior surface of slide 140 as is illustrated in FIGS. 3 and 4. Consequently, when slide 140 moves along ribs 118, 126, magnet 144 moves with slide 140 as a unit.

In accordance with another specific feature of the present invention, dipole magnet 144 is also specially manufactured to create a specific pole at the planar face 186 and the other pole at the arcuate face 188 of the magnet. This is done so that only the appropriate magnetic pole is brought into proximity of the locking mechanism when magnet 144 is inserted into the recess in security device 200. If the incorrect magnetic pole is brought into the proximity of the locking mechanism in the security device, then the locking mechanism would be repelled by the magnet and would remain in a locked position. Thus, dipole magnet 144 is manufactured so that one of the north or south poles of the magnet 144 is created at the planar face 186 and the other of the north and south poles is created at a portion of arcuate face 188 directly opposite planar face 186. In the preferred embodiment of the invention, planar face 186 is the part of magnet 144 which is used to unlock the locking mechanism of security device 200.

It is contemplated that a plurality of industry or store-specific keys 100 will be manufactured. Each key will have a specific and differently cross-sectionally shaped dipole magnet that will enable the key to be engaged only in complementary shaped recesses in specially produced security devices for that industry or store. The dipole magnet may therefore be manufactured with cross-sectional profiles other than D-shaped, such as a trapezoidal shaped profile. It will be understood that a complementary shaped slide would be provided to retain and manipulate the differently shaped magnet.

Key 100, as illustrated in the attached drawings, is designed for use by a right-handed person. It is contemplated that the user will hold the device in their right hand with their thumb resting on button 144 and the orientation of key 100 will be such that the planar face 186 of magnet 144 will face downwardly toward the ground. It will be understood by those skilled in the art that key 100 could be alternatively or additionally be manufactured in a left-handed version.

FIGS. 6 and 9 show that recessed region 103 of housing 102 is shaped to accommodate a surface portion of a cylindrical rod 202 of a display rod assembly 204 therein when key 100 is to be used to unlock security device 200. When recessed region 103 is positioned on rod 202, the rod 202 acts as a guide to correctly orient and direct key 100 toward the recess 206 in security device 200 as will be hereinafter described. Security device 200 is a base assembly for locking rod assembly 204 to a display board 210. Rod assembly comprises includes upper rod 202 and a lower rod 203. Security device 200 also includes a locking mechanism 250 that is contained within a chamber 252 secured within the interior of the device. Locking mechanism 250 is separated from direct contact with key 100 by a wall 254 that is of sufficient depth that if an over-the-counter magnet was placed on the outer surface of security device 200, mechanism 250 would remain locked. Locking mechanism 250 preferably is also not directly accessible or engageable by way of a conventional key or switch.

Locking mechanism 250 includes a metallic shuttle assembly 256 that is biased by a spring 258 into a passageway 260 through which the rod 202 passes thus locking rod 202 in place. Locking mechanism 250 also includes a nonmetallic, insulating base portion 262 made out of a material such as a plastic. Insulating base portion 262 is positioned between the metal of shuttle assembly 256 and the metal of rod 202 to substantially prevent rod 202 from being attracted to magnet 198 in shuttle assembly 256. When locking mechanism 250 extends into passageway 260, base portion 262 is received in a notch 262 in rod 202 and thereby locks rod 202 and base assembly 200 together. When locking mechanism 250 is in an unlocked position, base portion 262 is withdrawn from notch 262 in rod 202 and rod 202 is therefor free to move. It should be noted that locking mechanism 250 moves between a locked and unlocked position in a direction that is substantially at right angles to passageway 260.

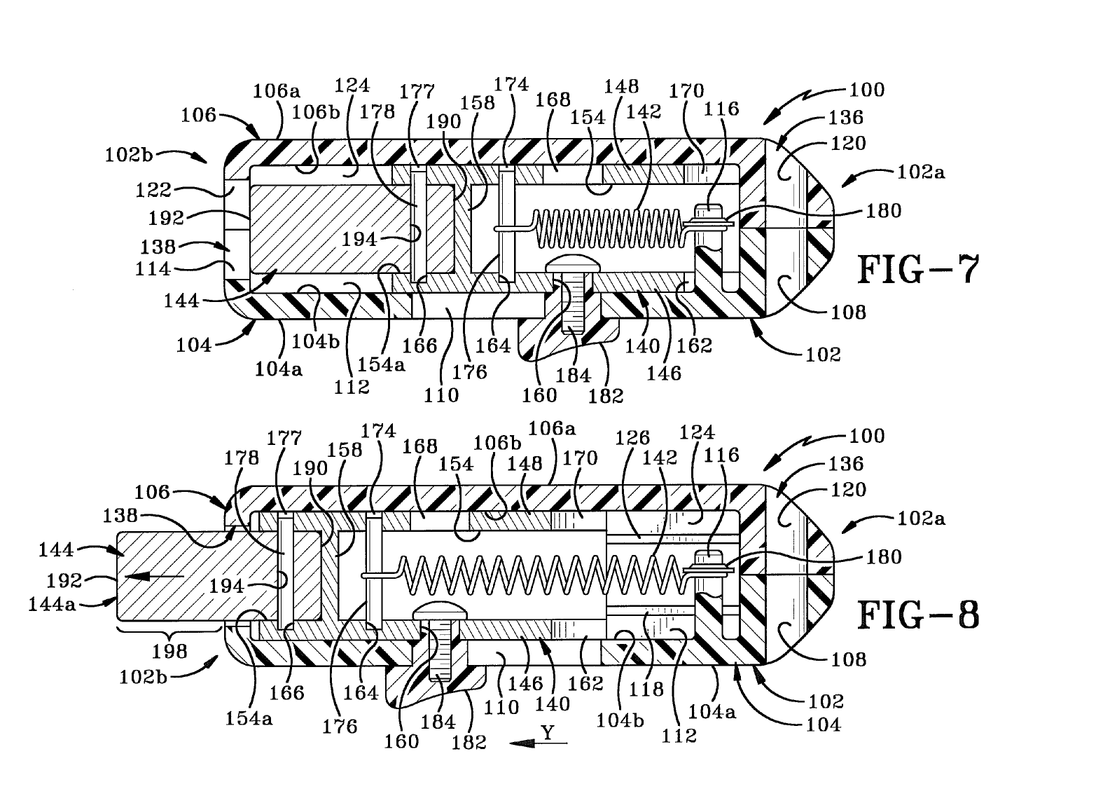

Key 100 is used to unlock locking mechanism 250 in the security device in the following manner. The store employee holds key 100 in their right hand and pushes button 144 in the direction of arrow “Y” (FIG. 4). It should be noted that button 144 is configured to have a sloped upper end terminating in an upstanding portion 144a so that it is easier to engage. The pushing of button 144 in the direction of arrow “Y” causes slide 140 to move within housing 102 from a first position (FIG. 7) to a second position (FIG. 8). In the first position, shown in FIG. 7, key 100 is in an inactive position and slide 140 is positioned in such a way that substantially the entire magnet 144 is retracted into the interior chamber 154 of housing 102. As button 144 is pushed in the direction of arrow “Y”, slide 140 is moved within the interior of housing 102 along ribs 118, 126 and toward end 102b of housing 102. This movement of slide 140 causes spring 142 to be expanded from a first length shown in FIG. 3, to a second length shown in FIG. 4. Furthermore, the movement of slide 140 toward second end 102b of housing 102, causes an outer end 144a of magnet 144 to slide out of housing 102 through opening 138 in second end 102b thereof and into a second extended position. When magnet 144 in this extended position, a relatively small portion thereof remains within housing 102 and a second, larger portion thereof extends outwardly from housing 102. The portion of magnet 144 that extends outwardly away from housing 102 forms a magnetic protuberance 198 (FIG. 4) that is insertable into recess 206 of security device 200 to unlock the same. When protuberance 198 extends outwardly from housing 102, slide 140 is in the second position.

When key 100 is in this active state with magnet 144 extended outwardly away from housing 102, the store employee then positions housing 102 on rod 202 so that the upper surface thereof is seated in recessed region 103 of security device 200 (FIGS. 6 and 9). Housing 102 is pushed along rod 202 until magnetic protuberance 198 enters the complementary shaped recess 206 in security device 200. Protuberance 198 is of a length complementary to the length of recess 206 it is designed to be engaged in. This ensures that magnet 144 enters recess 206 to a degree sufficient to enable the force field emanating therefrom to enter the sphere of locking mechanism 250. The correct pole of dipole magnet 144 is thereby brought into the proximity of locking mechanism 250. The magnetic field of magnet 144 that extends between the north and south poles thereof attracts locking mechanism 240 upwardly within chamber 252 and thereby withdraw the base portion 262 thereof out of the notch 264 in rod 202. More specifically, the planar face 186 of magnet 144 is placed in contact with a surface of security device 200, in this case an interior surface of wall 254 proximate recess 206, where it is disposed proximate a metallic element of locking mechanism 250. The dipolar magnet 144 attracts shuttle assembly 256, toward it, thereby moving the locking mechanism 250 orthogonally relative to passageway 260 from a locked condition to an unlocked condition.

When the store employee is finished conducting his/her business with security device 200, button 144 on housing 102 is released. This causes spring 142 within housing 102 to contract and return to its original shape and position and thereby withdraw slide 140 along tracks 126 and back into the interior of housing 102 in the opposite direction to the arrow “Y”. As slide 140 moves toward end 102a of housing 102, magnet 144 slides with it and protuberance 198 is retracted back into the interior chambers 112, 124 of housing 102. Thus, slide 140 is moved back to its first position and key 144 is again inactive.

The preferred embodiment of the present invention has been illustrated showing that the opening 138 and magnet 144 are generally D-shaped and slide 140 is shaped to accommodate the magnet 144. The D-shaped magnet 144 is designed to be engaged in a complementary D-shaped recess in a security device 200. This complementary relationship between the magnet and security device 200 aids in ensuring that security device 200 cannot be unlocked by unauthorized parties. It will be understood by those skilled in the art, however, that the dipole magnet may be formed in any other desired shape and that the other shaped magnet will be retained within a complementary shaped slide and extended through a complementary shaped opening in the housing and inserted into a complementary shaped recess and a security device 200 to be unlocked.

It should be understood that magnet 144 could be manufactured with a specific cross-sectional shape that is complementary to a recess in a security device 200 and then used all by itself, i.e., without keeping the magnet retained within a housing. However, it is preferable to connect magnet 144 to slide 140 and retain magnet 144 within housing 102 for several reasons. The first reason is for the protection of the magnet against dropping, chipping and overall reduction in the magnetism thereof as previously described. Dipolar magnets are also far stronger than “regular” magnets. Consequently, if magnet 144 was not protected by housing 102 it would attract surrounding objects to itself such as car keys, coins, paper clips etc.

It will be understood that while the locking mechanism 250 in security device 200 has been disclosed as attracted toward the dipole magnet of key 100, locking mechanism 250 could alternatively be set up within base assembly 200 to be repelled by the magnet and, when so repelled, become disengaged with the rod of rod assembly 204.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. A key for unlocking a magnetically attractable locking mechanism contained within the interior of a security device, said key comprising:
a housing;
a dipole magnet mounted within a chamber in the housing; said magnet being movable between a retracted position where substantially all of the magnet is located within the housing; and an extended position where at least a portion of the magnet projects outwardly from the housing; and when the magnet is in the extended position and is brought into the proximity of the locking mechanism, a force field from the magnet moves the locking mechanism from a locked position to an unlocked position.

2. The key as defined in claim 1, wherein the dipole magnet has a distinct cross-sectional shape and is adapted to be received within a complementary shaped recess within the security device.

3. The key as defined in claim 2, wherein the dipole magnet is substantially D-shaped in cross-section and is adapted to be received within a complementary D-shaped recess within the security device.

4. The key as defined in claim 3, wherein the dipole magnet has a first end, a second end and an elongated wall extending therebetween; and wherein said dipole magnet has a longitudinal axis extending between the first and second ends and moves in the housing between a retracted and extended position substantially along said longitudinal axis.

5. The key as defined in claim 4, wherein the elongated wall of the dipole magnet includes:
a substantially planar face; and
an arcuate face that originates and terminates in the planar face to form the D-shaped cross-section.

6. The key as defined in claim 5, wherein the dipole magnet is manufactured so that the planar face constitutes one of the north and south poles of the magnet and the arcuate face constitutes the other of the north and south poles of the magnet.

7. The key as defined in claim 1, wherein the dipole magnet is a neodymium iron boron magnet.

8. The key as defined in claim 1, wherein the housing comprises:
a first section; and
a second section, and wherein each of said first and second sections defines a portion of an interior chamber that is complementary shaped and sized to receive the magnet therein; and wherein said first and second sections each define a portion of an opening to the interior chamber; and wherein said magnet is moveable through said opening between the retracted and extended positions.

9. The key as defined in claim 8, wherein the housing further includes at least one track formed on an interior surface of the first side of the housing; and wherein said magnet is movable along said track.

10. The key as defined in claim 9, wherein the housing further includes a slide, said slide defining an interior bore complementary to receive a second portion of said magnet therein; and wherein said slide is reciprocally movable along said track to move the magnet between the extended and retracted positions.

11. The key as defined in claim 10, wherein the first side includes a pair of spaced apart, longitudinally aligned tracks, and the slide includes a pair of spaced apart lips that are engageable with said tracks to secure the slide thereto.

12. The key as defined in claim 11, wherein the magnet defines a groove in the planar face thereof, said groove being positioned at right angles to the longitudinal axis of the magnet; and wherein the slide further includes a pin that extends between a first and second face of the slide and through the groove in the magnet to lock the magnet and slide together.

13. The key as defined in claim 12, further comprising a tension spring that extends between the slide and one of the first and second sides of the housing; and wherein said spring biases the slide and therefor the magnet into the retracted position within the housing.

14. The key as defined in claim 13, further comprising a post that extends inwardly from one of the first and second sides of the housing and into the interior chamber thereof; and wherein the spring is secured to the post at one end and to the slide at the other end.

15. The key as defined in claim 14, wherein the housing further includes an actuator button that is movable along a slot defined in one of the first and second sides of the housing, said button being movable between a first and a second position; and wherein the actuator button is operationally connected to the slide to move the slide along the first and second tracks within the housing.

16. The key as defined in claim 15, wherein the actuator button is movable from the first position to the second position by external finger pressure being applied thereto; and when the actuator button is moved from its first position to its second position along the housing, the spring is caused to expand, and when finger pressure on the actuator button is released, the spring contracts to its original length and position.

17. The key as defined in claim 1, wherein the housing further defines a second chamber therein and the key further comprises one of a long AM coil and RF coil that are retained within the second chamber.

18. The key as defined in claim 1, wherein the housing further includes an axial groove defined in a portion of an exterior surface of the housing, said axial groove being adapted to receive a rod-like portion of the security device therein; whereby the rod-like portion acts as a guide for directing the engagement of the housing with the security device.

19. The key as defined in claim 1, wherein the housing further includes a slot defined in an exterior surface thereof; said slot being adapted to receive a lanyard connector therethrough.

20. In combination:
a security device defining a chamber positioned inwardly from an exterior surface thereof;
a magnetically attractable locking mechanism disposed in the chamber and being adapted to lock the security device to an object; said locking mechanism being linearly movable within the chamber between a locked and an unlocked position;
a recess extending inwardly into the device from the exterior surface thereof and orthogonally to said interior chamber and to the linear movement of the locking mechanism therein; said recess being formed with a distinct cross-sectional shape and being separated from the chamber by an interior wall;
a key comprising:
a housing;
a dipole magnet mounted within the housing and being movable between a retracted position where substantially all of the magnet is located within the housing, and an extended position where at least a portion of the magnet projects outwardly from the housing; said dipole magnet having a cross-sectional shape complementary to that of the recess; and when said magnet is in the extended position and inserted into the recess, it magnetically moves the locking mechanism from the locked position to the unlocked position.
